(19) United States
(12) Patent Application Publication
(10) Pub. No.: US 2016/0142471 A1
(43) Pub. Date: May 19, 2016

(54) SYSTEMS AND METHODS FOR FACILITATING COLLABORATION AMONG MULTIPLE COMPUTING DEVICES AND AN INTERACTIVE DISPLAY DEVICE

(71) Applicant: Smart Technologies ULC, Calgary (CA)

(72) Inventors: Edward Tse, Calgary (CA); Ian Hargreaves, Calgary (CA)

(21) Appl. No.: 14/542,832

(22) Filed: Nov. 17, 2014

(51) Int. Cl. H04L 29/08; H04L 29/06; G06F 3/0484

(52) U.S. Cl. CPC H04L 67/10; G06F 3/0484; H04L 65/403; H04L 67/14

(57) ABSTRACT

Systems, devices, and methods are provided for providing interactive collaboration among computing devices. In some aspects, an interactive display device can display a graphical interface corresponding to a shared workspace. The interactive display device can communicate with multiple computing devices, each computing device associated with a virtual position. A processing device of the interactive display device can update the graphical interface to depict the respective virtual positions associated with each computing device. For each computing device, the interactive display device can also provide access to a respective portion of the shared workspace indicated by the respective virtual position associated with the computing devices. The processing device can trigger an action on the interactive display device based on determining that a subset of computing devices have performed a threshold activity.

### TECHNICAL FIELD

This disclosure relates generally to computer-implemented methods and systems for collaborative shared workspaces and more particularly relates to a system for facilitating collaboration among an interactive display device and multiple computing devices via a shared workspace.

### BACKGROUND

Interactive whiteboards and other interactive display devices can provide touch detection for computer applications and can display electronic content to large groups of users. For example, interactive whiteboards may be used in collaborative settings (e.g., in a classroom) in which multiple users add, modify, or otherwise manipulate electronic content via the whiteboard. Users can also add or modify to the electronic content of the whiteboard via mobile devices.

Prior solutions for providing interaction between an individual mobile device and an interactive whiteboard may present limitations. For example, interactive whiteboards and software executing on interactive whiteboards may not provide individualized, private access to the electronic content associated with the interactive whiteboard. These interactive whiteboard systems may not provide the ability for mobile devices to individually access and navigate through portions of the electronic content using the interactive whiteboard.

An interactive whiteboard system that can monitor and execute different actions based on the interactions of mobile devices on private portions of the electronic content can further facilitate collaboration in a group environment.

### SUMMARY

Systems and methods are described for facilitating collaboration between multiple computing devices and an interactive display device.

For example, an interactive display device can display a graphical interface corresponding to a shared workspace. A processing device that may be included in or communicatively coupled to the interactive display device can monitor computing devices that access the interactive display device via a data network. Each of the computing devices can be associated with a virtual position in the shared workspace. The processing device can update the graphical interface to depict respective virtual positions associated with the computing devices. For each computing device, access can be provided, via the interactive display device, to a respective portion of the shared workspace that is indicated by a respective virtual position associated with the computing device. The processing device can trigger an action on the interactive display device based on determining that a threshold activity has been performed by a subset of the computing devices.

These illustrative examples are mentioned not to limit or define the disclosure, but to provide examples to aid understanding thereof. Additional aspects and examples are discussed in the Detailed Description, and further description is provided there.

### BRIEF DESCRIPTION OF THE FIGURES

These and other features, aspects, and advantages of the present disclosure are better understood when the following Detailed Description is read with reference to the accompanying drawings.

FIG. 1 is a block diagram depicting an example of a computing environment in which an interactive display device can communicate with multiple computing devices according to certain aspects of the present invention.

FIG. 2 is a block diagram depicting an example of the interactive display device executing a shared workspace application for monitoring and plotting the virtual positions of computing devices according to certain aspects of the present invention.

FIG. 3 is a diagram depicting an example of an interactive display device displaying a graphical interface associated with a shared workspace and examples of computing devices with respective graphical interfaces associated with portions of the shared workspace according to certain aspects of the present invention.

FIG. 4 is a flowchart depicting an example of a method for monitoring and displaying virtual positions associated with computing devices on a shared workspace according to certain aspects of the present invention.

FIG. 5 is a diagram depicting an example of displaying a new shared workspace on an interactive display device based on one or more computing devices performing a certain task according to certain aspects of the present invention.

FIG. 6 is a diagram depicting an example of an interactive display device that can embed linked content in portions of the shared workspace and examples of computing devices displaying the linked content according to certain aspects of the present invention.

FIGS. 7A and 7B depict examples of grouping computing devices according to certain aspects of the present invention.

FIG. 8 is a diagram depicting an interactive display device that tracks and displays virtual positions associated with and actions performed by computing devices over a period of time according to certain aspects of the present invention.

FIG. 9 is a block diagram depicting examples of an interactive display device and a computing device that can communicate according to certain aspects of the present invention.

### DETAILED DESCRIPTION

Systems, devices, and methods are described for facilitating collaboration among multiple computing devices and an interactive display device using a shared workspace. In some aspects, these collaboration features can provide tools for coordinating group activities in shared digital environments, such as (but not limited to) classroom settings. For example, activities can be coordinated in a digital education environment in which one view is shared (e.g., an interactive whiteboard used by a teacher) and multiple other views are private (e.g., private views of the digital education environment provided by students' respective personal computing devices).

The following non-limiting example is provided to help introduce the general subject matter of certain aspects. Users of an interactive whiteboard or other interactive display device may wish to use their mobile devices (or other computing devices) to collaborate on a common project. The interactive display device may display a graphical interface that is associated with a shared workspace and that is visible to users of the mobile devices. Each of the mobile devices or other computing devices can have access to the same collaborative shared workspace. For example, the shared workspace may be a virtual environment represented by a geographic map displayed in the graphical interface. Each of the mobile devices can be associated with a respective virtual position in the virtual environment. A virtual position can be indicated by, for example, a set of Cartesian coordinates (e.g., X, Y coordinates) and a zoom level with respect to the geographic map. The interactive whiteboard can display a graphical interface corresponding to the majority or entirety of the shared workspace. Each of the mobile devices can display a respective graphical interface corresponding to a portion of the shared workspace. Users can interact with the shared workspace by using their mobile devices to modify the virtual positions in the virtual environment and to perform one or more actions in the virtual environment.

For example, a user can interact with a graphical interface on a mobile device to display different portions of the shared workspace. The coordinates at the center of each user's graphical interface can correspond to the virtual position associated with the mobile device in the virtual environment. The mobile device can transmit or otherwise provide the coordinates to the interactive display device via a data network. A processing device included in or communicatively coupled to the interactive display device may track the virtual positions in the virtual environment associated with the mobile devices. The processing device can configure the interactive display device to display tokens or other visual indicators representing the virtual positions of the mobile devices in the virtual environment. Based on the actions performed by the mobile devices in the virtual environment, the processing device may modify the graphical interface that is displayed on the interactive display device. For example, based on certain actions performed by mobile devices, the graphical interface for the shared workspace may be modified to display previously hidden content or to provide access to a different shared workspace or a previously inaccessible portion of the shared workspace.

In accordance with some aspects, an interactive display device (e.g., an interactive whiteboard) can display a graphical interface associated with a shared workspace. The interactive display device can include or be communicatively coupled to a processing device. The processing device can monitor multiple computing devices that communicate with the interactive display device via a data network. Each of the computing devices is associated with a virtual position in the shared workspace. Each of the computing devices can display a portion of the shared workspace corresponding to the associated virtual position. In some aspects, the computing devices can display hidden content in the shared workspace. The hidden content is not displayed on the interactive display device. The processing device can plot the virtual positions associated with the computing devices on the shared workspace.

The processing device can determine if a subset of the computing devices has performed a threshold activity. In some aspects, the threshold activity can include moving the virtual positions associated with each of the subset of the computing devices to a pre-determined location or a set of locations in the shared workspace. In alternative or additional aspects, the threshold activity can include selecting a correct answer that is presented among a group of possible answers in the shared workspace. In response to determining that a subset of the computing devices has performed the threshold activity, the processing device can trigger an action on the interactive display device. In some aspects, the triggered action can include displaying a second shared workspace that is a subset of the shared workspace.

In additional or alternative aspects, the processing device can determine a subset of computing devices and create a restricted portion of the shared workspace. The restricted portion of the shared workspace can be accessible by members of the subset of the computing devices. The restricted portion of the shared workspace can be inaccessible to other computing devices that are not members of the determined subset of computing devices.

In further aspects, the processing device can track the virtual positions associated with the computing devices over a period of time. The processing device can also track actions performed by the computing devices over the period of time. The processing device can modify a graphical interface corresponding to the shared workspace to display the virtual positions associated with the individual display device over a period of time. In additional aspects, the processing device can list the actions performed by the computing devices. The processing device can also rank the list of actions by the number of computing devices that performed each action.

In additional or alternative aspects, the processor can embed linked content at a specific location in the shared workspace. The linked content may not be displayed on the shared workspace. The interactive display device can display, at the pre-determined location on the shared workspace, a node associated with the linked content. One or more of the computing devices can respond to input for moving a virtual position to the pre-determined location by displaying the linked content.

As used herein, the term “interactive display device” can refer to a device that can receive or otherwise detect touch inputs or other types of inputs from users and generate outputs in response to the received inputs. A non-limiting example of an interactive display device is an interactive whiteboard that can be communicatively coupled to a computing device.

As used herein, the term “computing device” can refer to any computing device configured to execute program code and to wirelessly communicate with the interactive display device and/or other computing devices. A computing device can include or be communicatively coupled to a display screen. Non-limiting examples of computing devices include smart phones, tablet computers, laptop computers, desktop computers, etc.

Computing devices can allow users to access and manipulate content on the interactive display device. For example, the computing device can display a portion of the content from the shared workspace based on user interaction. Users can manipulate an interface on the computing device to access a specific portion of the content (e.g., swiping the display on the computing device with a finger to indicate a specific position and zoom level of the content).

As used herein, the term “shared workspace” can refer to an interactive environment including electronic content that multiple computing devices can view and access. The shared workspace can be displayed on an interactive display device. A non-limiting example of a shared workspace includes a virtual environment depicted by a geographic map on the interactive display device.

As used herein, the term “virtual position” can refer to a set of coordinates in a shared workspace such as (but not limited to) Cartesian coordinates. A virtual position can also include information describing a zoom level with respect to a region of the shared workspace. The virtual position associated with a computing device can indicate which portion of the shared workspace the computing device is accessing and viewing.

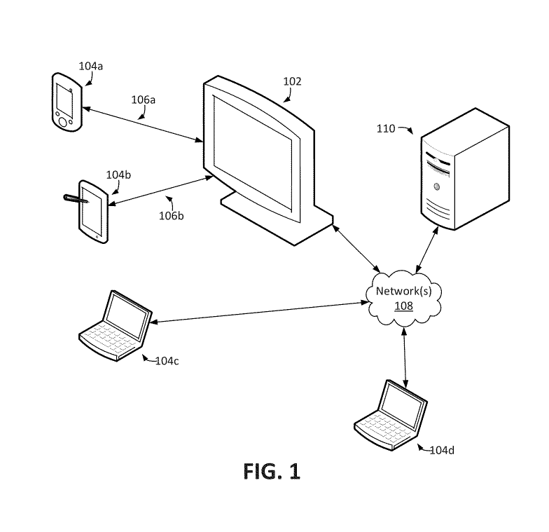

Referring now to the drawings, FIG. 1 is a block diagram depicting an example of a computing environment in which multiple computing devices 104a-d can collaborate using a shared workspace displayed on an interactive display device 102. A non-limiting example of an interactive display device 102 is an interactive white board or other touch screen device that is sufficiently large to be viewed by multiple individuals at a location in which the computing devices 104a-d are positioned. The computing devices 104a-d can display graphical interfaces corresponding to respective portions of the shared workspace. The interactive display device 102 can display a graphical interface corresponding to the entirety shared workspace or a portion of the workspace having a size greater than or equal to the combination of the portions of the shared workspace displayed on the computing devices 104a-d.

The interactive display device 102 can communicate with the computing devices 104a-d. Non-limiting examples of the computing devices 104a-d may include a smart phone, a tablet computer, a laptop computer, or any other computing device. In some aspects, a computing device can communicate directly with the interactive display device 102 via a short-range wireless communication link. For example, in the computing environment depicted in FIG. 1, the interactive display device is communicatively coupled to the computing devices 104a, 104b via respective short-range wireless links 106a, 106b (e.g., Bluetooth interface, a wireless RF interface, etc.). In additional or alternative aspects, a computing device can communicate with the interactive display device 102 via a server 110 or other computing device. In some aspects, the server 110 can include multiple servers configured for cloud computing. The server 110 or other computing device can communicate with the computing device and the interactive display device 102 via one or more suitable data networks 108. For example, in the computing environment depicted in FIG. 1, the interactive display device 102, the computing devices 104c, 104d, and a server 110 are communicatively coupled to one another via one or more data networks 108 (e.g., via an Ethernet network).

In some aspects, the interactive display device 102 and the computing devices 104a-d can utilize a set of software tools for providing a collaborative environment. This set of tools can treat each private screen view as a computing device's virtual position in a digital space. If views are zoomed in, the collaborative environment can track the virtual position of the view by plotting corresponding coordinates of the center of each mobile device screen. The shared workspace can be presented to all users of the mobile devices, with virtual positions of the mobile devices indicated on the interactive display device 102 using tokens that indicate the respective coordinates of the current viewpoints. Additional content and workspaces can also be linked to the main workspace on the interactive display device for individual users to explore with their mobile devices. Software executing on the shared workspace application can also track and manage mobile device interactions through easy grouping tools.

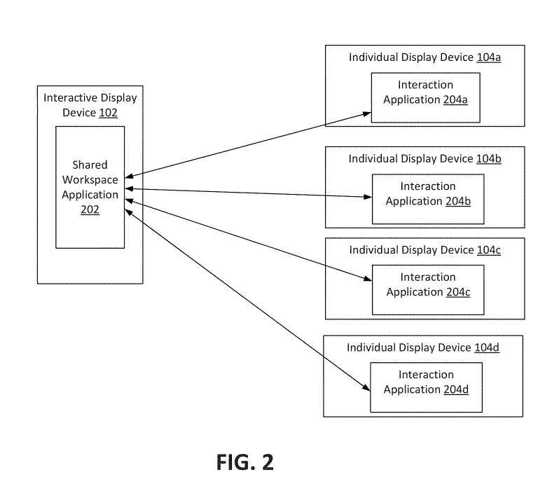

FIG. 2 is a block diagram depicting an example of the interactive display device 102 executing a shared workspace application 202 that can receive input data from shared interaction applications 204a-d that are executed by the computing devices 104a-d.

The shared workspace application 202 can include program code executable by one or more processing devices that are included in or communicatively coupled to the interactive display device 102. The program code can be included in software or firmware installed on a non-transitory computer-readable medium that is included in or communicatively coupled to the interactive display device 102. Executing the shared workspace application 202 can configure the interactive display device 102 to perform one or more operations for receiving inputs and presenting outputs in response to the inputs, as described in detail herein. For example, executing the shared workspace application 202 can output a shared workspace to a display screen included in or communicatively coupled to the interactive display device 102.

Each of the interaction applications 204a-d can include program code executable by one or more processing devices in a respective one of the computing devices 104a-d. The program code can be included in software or firmware installed on each of the computing devices 104a-d. Executing the interaction applications 204a-d can allow users of the respective computing devices 104a-d to provide input to the shared workspace application 202 or otherwise manipulate the content of the shared workspace. An interaction application can include any application suitable for communicating with the shared workspace application 202. Non-limiting examples of an interaction application include native applications specifically configured for communicating with the shared workspace application 202, web browser applications configured to access a shared workspace via the Internet, etc.

FIGS. 1 and 2 depict a single interactive display device 102 in communication with four computing devices 104a-d for illustrative purposes. Other implementations are possible. For example, any number of interactive display devices may communicate with any number of computing devices.

FIG. 2 depicts the shared workspace application 202 and the interaction applications 204a-d as individual functional blocks for illustrative purposes, but other implementations are possible. For example, one or more of the shared workspace application 202 and the interaction applications 204a-d may include program code that is integrated into or otherwise included in the program code of another application executed by a given device.

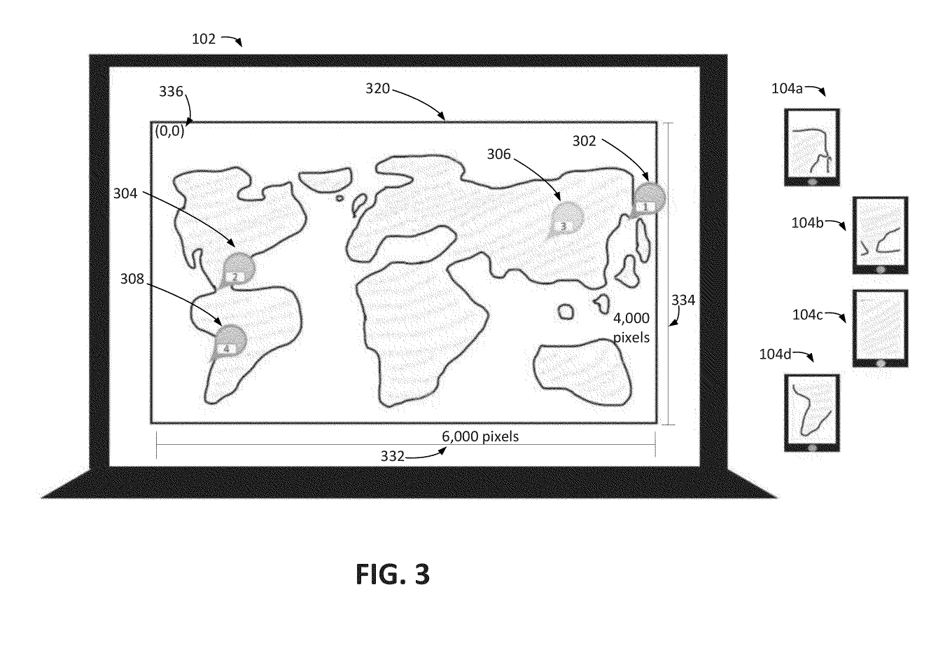

The collaborative system shown in FIGS. 1 and 2 can be used to share a collaborative workspace with multiple users. Each user can have his or her own computing device that can access the shared, collaborative workspace and display a portion of the collaborative workspace. For example, FIG. 3 is a diagram depicting an example of a shared workspace 320 that can be displayed on an interactive display device 102 and examples of portions of the shared workspace 320 that can be displayed on computing devices.

In the example depicted in FIG. 3, the interactive display device 102 displays a graphical interface for a shared workspace 320 that depicts a virtual environment as a geographic map. The graphical interface for the shared workspace 320 displayed on the interactive display device 102 is visible to users of the computing devices 104a-104d.

The boundaries of the shared workspace 320 can be defined by a coordinate space. A coordinate space can specify a maximum height and a maximum length for a graphical interface corresponding to the shared workspace 320. For example, the shared workspace 320 may have a maximum length 332 of 6,000 pixels and a maximum height 334 of 4,000 pixels. A virtual position on the shared workspace 320 can be identified using a set of coordinates within the coordinate space. For example, a coordinate set (0, 0) can identify a top left corner 336 of the shared workspace 320. A coordinate set of (6,000, 4,000) can identify the bottom right corner of the shared workspace 320. The interactive display device 102 and computing devices 104a-d can display subsets of the coordinate space.

The virtual position on the shared workspace 320 can also include a zoom level. The zoom level can be entered or otherwise selected using input received by one or more of the computing devices 104a-d. The zoom level can indicate the amount of the shared workspace 320 that is being selected for a given coordinate set. For example, a higher zoom level can encompass a smaller amount of pixels of the shared workspace 320. A lower zoom level can encompass a larger amount of pixels of the shared workspace 320. While a maximum length 332 of 6,000 pixels and a maximum height of 4,000 pixels are described for illustrative purposes, the exact number of pixels may vary depending on the implementation of the computing devices used.

Each of the computing devices 104a-d can independently display a portion of the shared workspace 320. For example, each display screen of a respective one of the computing devices 104a-d can show a different aspect of the shared workspace 320. Each of the computing devices 104a-d can also be associated with a virtual position monitored by the shared workspace application. The associated virtual positions of each of the computing devices can be updated based on manipulating the zoom level and changing the coordinates of the displayed portion on the computing devices 104a-d. In some aspects, each of the computing devices 104a-d can include output screens of varying resolutions.

A computing device can notify a processing device of the interactive display device 102 of a virtual position by transmitting data indicative of the virtual position to the processing device via a data network 108. The data indicative of the virtual position can include one or more of a coordinate set at the center of the displayed portion on the computing device, a zoom level, and a native resolution of the computing device. The shared workspace application 202 can use the data indicative of the virtual positions of the respective computing devices 104a-d to determine a respective portion of the shared workspace 320 viewed by each of the computing devices 104a-d.

For example, the interaction application 204a executing on the computing device 104a can receive one or more inputs (e.g., touch screen inputs caused by a finger being moved across a touch screen). The interaction application 204a can respond to receiving one or more inputs by modifying a graphical interface corresponding to a portion of the shared workspace 320 (e.g., by moving the graphical interface in one or more directions). The interaction application 204a can also receive one or more additional inputs of a different type (e.g., touch screen inputs such as a “flicking” gesture corresponding to a finger's rapid motion over a touch screen). The interaction application 204a can respond to receiving one or more additional inputs by modifying the graphical interface displayed on the computing device 104a to depict a new position in the shared workspace 320. Each of the computing devices 104a-d can also receive input changing the zoom level of the respective portion of the shared workspace 320 displayed by the computing device. For example, if a user swipes a touch screen of a computing device 104a with a certain gesture, the interaction application 204a can respond to receiving the swiping input by changing the zoom level of the portion of the shared workspace displayed on computing device 104a. The computing device 104a can display a more specific, focused area of the portion of the shared workspace 320 in response to receiving input for increasing the zoom level. The computing device 104a can also display a larger area of the portion of the shared workspace 320 in response to receiving input for decreasing the zoom level. In response to receiving additional inputs to depict a new position in the shared workspace 320, the interaction application 204a can update the associated virtual position (i.e., the associated coordinate set or zoom level). The interaction application 204a can store the associated virtual position and the native resolution of the computing device in a memory device of the computing device or provided to the interactive display device 102.

A processing device included in or communicatively coupled to the interactive display device 102 can monitor a virtual position associated with each of the computing devices 104a-d. Each of the virtual positions can include a specific coordinate set identifying a location in the shared workspace 320. The interactive display device 102 can display tokens 302, 304, 306, 308 corresponding to the virtual positions associated with the respective computing devices 104a-d, respectively.

The tokens 302, 304, 306, 308 can include any suitable visual indicators for identifying virtual positions in the shared workspace 320. For example, a token 302 represents the current virtual position associated with the computing device 104a. The computing device 104a can receive inputs selecting a different location in the shared workspace 320 to be displayed. The computing device 104a can respond to receiving these inputs by modifying a graphical interface corresponding to the shared workspace 320 to display a different portion of the shared workspace 320. The computing device 104a can also respond to receiving these inputs by modifying the virtual position associated with the computing device 104a in the shared workspace 320. The interactive display device 102 can update token 302 to reflect the modified virtual position associated with the computing device 104a.

In some aspects, each of the computing devices 104a-d can provide visual cues for identifying virtual positions associated with the other computing devices. For example, as the virtual position associated with computing device 104a approaches the virtual set of computing device 104b, the computing device 104a can display a token representing the virtual position of 104b. In some aspects, each of the computing devices 104a-d can provide visual cues in the form of different colors.

In the example shown in FIG. 3, a graphical interface corresponding to the shared workspace 320 includes a geographic map of planet Earth. Each of the computing devices 104a-d can display portions of the shared workspace 320 by displaying a portion of the geographic map. For example, a user of the computing device 104d is shown to be viewing a section of South America. Through user input, the portion of the map that is being shown can be changed. As described above, a user can swipe a touch screen or otherwise provide input to the computing device 104d to modify the graphical interface for a portion of the shared workspace 320 to display a different section of South America. The user can also provide input to the computing device 104d for changing the zoom level. An example of this input can include zooming outward to view the entire continent of South America or a larger region. An example of this input can include zooming into the shared workspace 320 so that a specific country or a specific city is shown on computing device 104d.

The granularity of the zoom levels and amount of detail that can be shown as the computing device receives input changing a zoom level can vary. For example, the computing device 104d can receive input for moving to a different virtual position in the shared workspace 320. The computing device 104d can respond to receiving the input by updating a graphical interface associated with a portion of the shared workspace 320 to display a different portion of Earth. Additionally or alternatively, the computing device 104d can respond to receiving the input by updating a graphical interface associated with a portion of the shared workspace 320 to change a zoom level to focus on a particular region. The computing device 104d can also respond to receiving the input by updating the virtual position associated with the computing device 104d to correspond to the different portion of the Earth and/or the different zoom level.

The set of tools depicted in FIG. 3 can facilitate collaboration for groups in various settings. For example, a teacher in an educational setting may use an interactive display device 102 to display a problem to students. The problem could direct the students to navigate to a specific geographic area in the shared workspace 320. Each student can use a respective one of the computing devices 104a-d to navigate to what he or she believes is the correct answer and press a selection key on the computing device. If a processing device for the interactive display device 102 determines that a threshold percentage of the students navigated to the correct answer (i.e., that the virtual positions associated with the computing devices are within a threshold distance of the correct answer), the interactive display device 102 may reveal previously hidden content indicating that the students chose the correct answer.

In another example, a teacher may use an interactive display device 102 to display a problem and a series of multiple-choice responses. The shared workspace application 202 can monitor the virtual positions associated with each of the computing devices 104a-d. If a processing device for the interactive display device 102 determines that a threshold percentage of the computing devices navigated to the correct multiple-choice response (i.e., that the virtual positions associated with the computing devices are within a threshold distance of the correct answer), the interactive display device 102 may reveal additional hidden content.

In the examples described above, a first graphical interface for a shared workspace 320 can be displayed on the interactive display device 102 as a canvas with properties for maximum height and maximum length. In some aspects, the shared workspace application 202 can respond to a shared workspace 320 being initialized by providing the canvas and related properties to each interaction application executing on a respective computing device. Each computing device can display a respective graphical interface depicting a respective portion of the shared workspace 320.

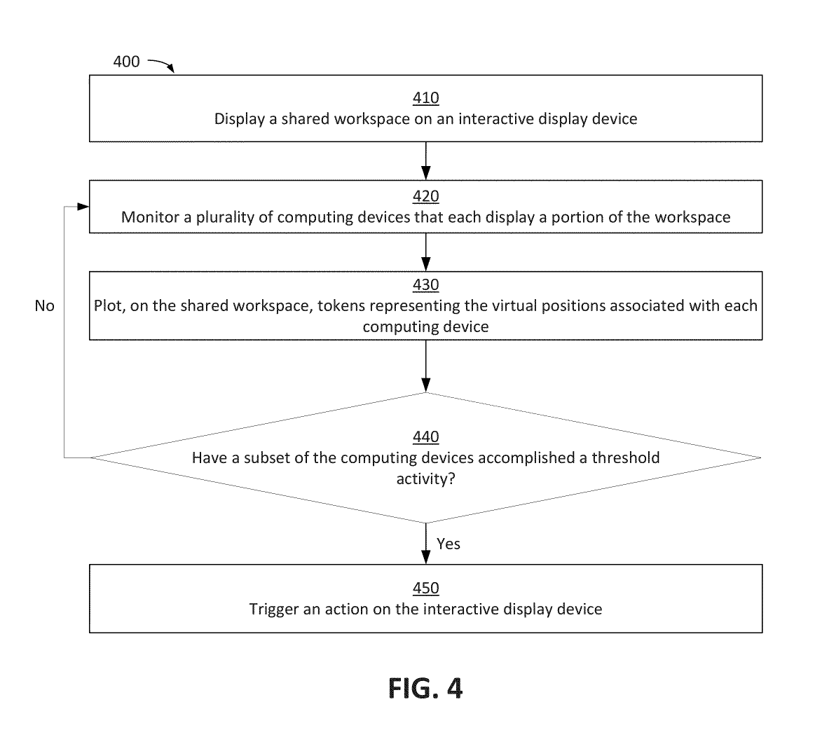

Users operating the computing devices 104a-d can explore and interact with the shared workspace 320 in any suitable manner. For example, FIG. 4 is a flowchart depicting an example of a method 400 for displaying a shared workspace 320 and monitoring interactions of computing devices 104a-d with the shared workspace 320. For illustrative purposes, the method 400 is described with reference to the devices depicted in FIGS. 1-3. Other implementations, however, are possible.

The method 400 involves displaying a shared workspace 320 on an interactive display device 102, as depicted in block 410. For example, the interactive display device 102 can include a processing device that executes suitable program code defining a shared workspace application 202. In some aspects, the processing device can be included in the interactive display device 102. In additional or alternative aspects, the processing device can be included in a separate computing device and communicatively coupled to the interactive display device 102. The shared workspace application 202 can be stored on a memory device that is included in or communicatively coupled to the interactive display device 102. Executing the shared workspace application 202 can result in displaying a graphical interface associated with the shared workspace 320.

As explained above with respect to FIG. 3, the shared workspace 320 can depict a virtual environment using, for example, a geographic map. In other aspects, a shared workspace 320 can depict other graphical interfaces including other presentation material. Examples of such presentation material include narrative text, images, videos, or other media. In some aspects, the shared workspace 320 can include hidden content that is not displayed on the interactive display device 102. The hidden content can be displayed at one or more of the computing devices 104a-d in response to a certain condition being satisfied (e.g., one or more of the computing devices 104a-d performing a threshold activity).

The method 400 further involves monitoring multiple computing devices 104a-d that display respective portions of the shared workspace 320, as shown in block 420. For example, each of the computing devices 104a-d can include a processing device that executes program code defining an interaction application for displaying a portion of the shared workspace 320. The interaction application can be stored in a memory of the computing device. Executing the interaction application can result in receiving information pertaining to the shared workspace application 202 (e.g., the content of the shared workspace 320, the coordinate ranges defining the boundaries of the shared workspace 320, etc.). Executing the interaction application can also result in displaying a portion of the shared workspace 320 on an output device, such as an LCD screen, on the computing device.

Each of the computing devices 104a-d can be associated with a virtual position in the shared workspace 320. The virtual position can include a coordinate set defining a specific pixel or set of pixels in the shared workspace 320. The virtual position can also include a zoom level that indicates the amount of area around the specific coordinate set that is displayed on the computing device. In some aspects, the virtual position of the computing device can be stored in the memory of the computing device. The virtual position associated with the computing device indicates the specific portion of the shared workspace 320 that is shown on or otherwise associated with the computing device.

The interactive display device 102 can monitor the computing devices 104a-d by listening for, monitoring, or otherwise detecting information regarding actions performed by one or more of the computing devices 104a-d with respect to the shared workspace 320. For example, an interaction application executing on a computing device can receive inputs from an input device included in or communicatively coupled to the computing device. The user can enter inputs to manipulate the portion of the shared workspace 320 that is displayed on the computing device. For example, the inputs received by a computing device can indicate commands for modifying one or more of a position depicted in a graphical interface corresponding to a portion of the shared workspace 320 and a zoom level for the graphical interface. Modifying one or more of a position depicted in the graphical interface and a zoom level for the graphical interface can modify the virtual position associated with the computing device. The user can also enter other inputs, such as (but not limited to) pressing a key to indicate a selection or entering textual data. The interaction application can process each input and provide data corresponding to the inputs (e.g., a command to modify a computing device's virtual position) to the shared workspace application 202 executing on the interactive display device 102. For example, the computing devices 104a-d can provide data to the interactive display device 102 via wireless transceivers included in the computing devices 104a-d and interactive display device 102.

A processing device for the interactive display device 102 can monitor and process the data provided from one or more of the computing devices 104a-d. For example, the inputs from the computing devices 104a-d can be provided to the shared workspace application 202. The shared workspace application 202 can process the inputs and execute certain functions in response to the inputs from the computing devices 104a-d.

The interactive display device 102 can monitor operations by the computing devices 104a-d with respect to the shared workspace 320. For example, the interactive display device 102 can receive the virtual positions of each of the computing devices 104a-d. The computing devices 104a-d broadcast the coordinate set and the current zoom level (the virtual position in the shared workspace 320) to the interactive display device 102.

The method 400 further involves plotting, by the interactive display device 102, the virtual positions of each of the computing devices 104a-d on the shared workspace 320, as depicted in block 430. For example, a computing device can provide a virtual position associated with the computing device to processing device of the interactive display device 102. The virtual position can include a coordinate set and a zoom level. The shared workspace application 202 can configure the interactive display device 102 to display a token corresponding to the virtual position in the shared workspace 320 that is associated with the computing device. For example, the interactive display device 102 can be configured to render a token at a coordinate set indicated by the virtual position provided by the computing device.

Referring to FIG. 3, the interactive display device 102 can plot the virtual positions of the computing devices 104a-d via respective tokens 302, 304, 306, and 308 on a graphical interface corresponding to the shared workspace 320. One or more of the computing devices 104a-d can receive input changing the portion of the shared workspace that is to be displayed on the computing device. Each computing device can respond to this input by updating a graphical interface displayed on the computing device to reflect the changed position. Each computing device can also respond to this input by updating the virtual position associated with the computing device. The interactive display device 102 that monitors the computing devices 104a-d can receive data via a data network from the computing devices identifying the updated virtual positions. The interactive display device can update the location of the tokens associated with the updated virtual positions on the graphical interface corresponding to the shared workspace 320.

In some aspects, the interactive display device 102 can also indicate a zoom level associated with a virtual position. For example, a token displayed on a graphical interface for the shared workspace 320 can vary in size based on the zoom level. If a computing device has been used to select a more focused zoom level, the interactive display device 102 can display the token as a circle encompassing a smaller area of the graphical interface corresponding to the shared workspace 320.

In the examples above, the virtual positions associated with each of the computing devices 104a-d are stored in the memory devices of the computing devices 104a-d and provided to the interactive display device 102. In other aspects, the virtual positions associated with each of the computing devices 104a-d can be stored in the memory of the interactive display device 102. An interaction application executed on a computing device can receive input for changing the portion of the shared workspace 320 to be displayed or for changing the zoom level at which the portion of the shared workspace 320 is to be displayed. The interaction application can configure the computing device to transmit or otherwise provide the input to the interactive display device 102. The interactive display device 102 can update the virtual position associated with the computing device and update the location of the token indicating the virtual position accordingly.

The method 400 further involves determining if a subset of the computing devices 104a-d have performed a threshold activity, as depicted in block 440. For example, the shared workspace application 202 can perform an algorithm that triggers one or more responsive actions if a certain number of computing devices 104a-d have performed a threshold activity. The shared workspace application 202 can monitor for this threshold activity and execute certain functions in response to determining that the threshold activity has been performed.

For example, the shared workspace 320 can include certain hidden content that is not visible on the shared workspace 320. If the shared workspace 320 is a geographic map, an example of hidden content can include invisible boundaries on the borders of geographic or political entities. The shared workspace application 202 executing on the interactive display device 102 can determine if a certain number of users focus in on a certain geographic region within hidden boundaries in the shared workspace 320. Specifically, the shared workspace application 202 can determine if virtual positions associated with the computing devices 104a-d include virtual positions with coordinate sets and zoom levels within the hidden boundaries.

The method 400 further involves the interactive display device 102 triggering an action based on a subset of computing devices performing a threshold activity, as shown in block 450. For example, the shared workspace application 202 can determine whether the threshold activity is performed and can execute one or more specific functions in response to the determination. Returning to the hidden content in a geographic or political map example discussed above, in response to determining that a certain number of computing devices have virtual positions associated with a specific geographic region, the shared workspace application 202 can execute an action such as outputting a different shared workspace to the interactive display device 102. The different shared workspace can be a subset of the original shared workspace 320. In some aspects, the different shared workspace can be restricted to specific users associated with specific computing devices. For example, the different shared workspace may be restricted to computing devices associated with users having one or more of a specified skill level (e.g., a skill level identified by or previously demonstrated by a user of a given computing device for operating in the different shared workspace), a specified assignment (e.g., a project or task assigned to the user involving the different shared workspace), a specific preference (e.g., a preference identified by a user of a given computing device to operating in the different shared workspace), etc.

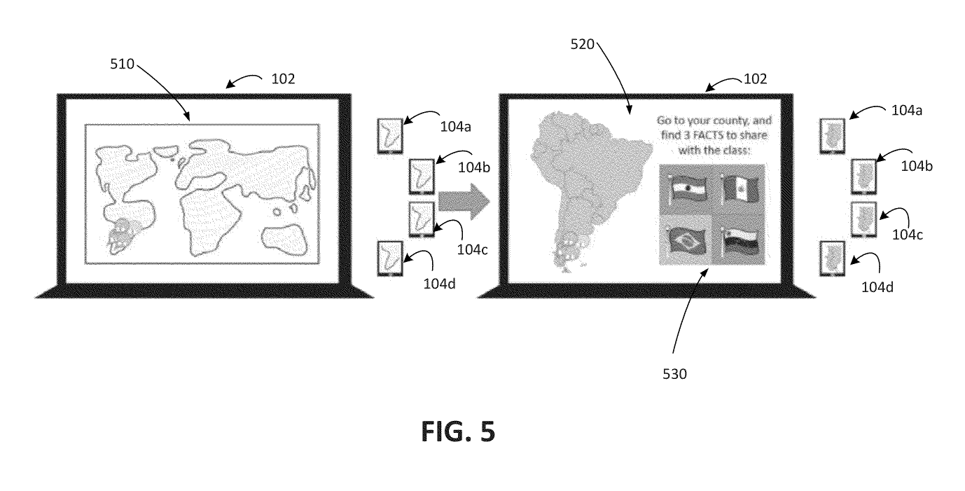

FIG. 5 shows an example of an interactive display device 102 that presents a first shared workspace 510 and a second shared workspace 520 in response to determining that a threshold activity has been performed by computing devices 104a-d. The first shared workspace 510 depicts a geographic map of planet Earth and can include hidden content defining boundaries of geographic or political entities. In the example shown in FIG. 5, invisible boundaries define the region of South America on the first shared workspace 510. The shared workspace application 202 executing on the interactive display device 102 can determine whether a certain number of computing devices 104a-d focus on the region defined by the invisible boundaries marking South America. Users of the computing devices 104a-d can provide inputs for changing which portions of the first shared workspace 510 are displayed and thereby focus the individual displays on the continent of South America.

The shared workspace application 202 associated with the interactive display device 102 can determine whether some or all of the associated virtual positions of the computing devices 104a-d include coordinate sets within the invisible boundaries of South America and include zoom levels displaying the continent of South America. The shared workspace application 202 can respond to this determination by displaying a second shared workspace 520. The second shared workspace 520 depicted in FIG. 5 is a geographic map focusing on the continent of South America. The computing devices 104a-d can be updated to display portions of the second shared workspace 520.

The shared workspace application 202 can use zoom levels for different computing devices to determine whether to display the first shared workspace 510. For example, larger zoom levels may define larger areas of the first shared workspace 510 and thus not trigger a response from the shared workspace application 202.

As another example of triggering an action in response to computing devices 104a-d performing a threshold activity, a processing device can configure the interactive display device 102 to present a query to the users (e.g., by presenting a question to a class in an educational setting). Users can select the correct answer by selecting inputs on the computing devices 104a-d. The shared workspace application 202 can determine if each of the users have answered the query correctly. For example, a teacher can present a query via the interactive display device 102 for the students to find a city with a population over 1 million. The interactive display device 102 can display a large geographic map of planet Earth. Each of the computing devices 104a-d can receive inputs from a respective student for exploring the map. The computing devices 104a-d can respond to the inputs by manipulating the graphical interface on the computing device to display different portions of the map and different zoom levels of the map. For example, the computing devices 104a-d can respond to receiving inputs for increasing the zoom level corresponding to various portions of the shared workspace 320 by updating graphical interfaces displayed on the respective computing devices to display additional geographic details, such as (but not limited to) countries, cities, rivers, and other geographic content in the virtual geographic map.

The shared workspace application 202 can monitor communications received from the computing devices 104a-d to determine if a threshold activity has been performed. For example, —the shared workspace application 202 can monitor communications received from the computing devices 104a-d to determine if a student operating one of the computing device 104a-d has navigated the associated virtual position to a coordinate set and zoom level of the shared workspace 320 such that a city with a population over 1 million is shown on the computing device. The shared workspace application 202 can compare the coordinate set and zoom level reported by one or more of the computing devices 104a-d with a list of correct answers stored in the memory device of the interactive display device 102. For example, the shared workspace application 202 can compare the X, Y coordinate set of a virtual position associated with a computing device with the X, Y positions of the correct answers. The shared workspace application 202 can also compare the zoom level of the virtual position to ensure that a threshold distance condition is satisfied. A threshold distance condition can include a determination of whether a sufficiently focused portion of the shared workspace 320 is displayed on a given computing device.

In some aspects, the shared workspace application 202 can be configured such that a range of coordinate sets around a correct coordinate set can satisfy the threshold condition. For example, if a particular user has navigated the virtual position to a coordinate set within a certain range and zoom level of a correct answer (e.g., the city of Nagoya), the shared workspace application 202 can execute one or more functions indicating the threshold condition for that computing device is satisfied.

In some aspects, the shared workspace application 202 can implement techniques to provide visual feedback on the computing devices 104a-d. For example, a particular user may use a computing device to select a portion of the shared workspace 320 corresponding to a virtual position close in proximity to a coordinate set that is associated with the correct answer. The shared workspace application 202 can respond to receiving information about the user's activity by transmitting commands to the interaction application on the computing device to highlight portions of the screen of the computing device or provide colored hues as hints in the direction of the correct answer. In another example, the shared workspace application 202 can transmit a command to the interaction application on the computing device to snap the displayed portion of the shared workspace 320 to the correct coordinate set.

As another example, FIG. 5 depicts the interactive display device 102 displaying a query asking users to navigate to their country and share three facts. The second shared workspace 520 can include further hidden content, such as political facts or other information about each of the countries shown in the second shared workspace 520. The hidden content may not be displayed on the interactive display device 102. The hidden content can be viewed on one or more of the computing devices 104a-d. The computing devices 104a-d can respond to inputs indicating movement throughout the second shared workspace 520 by displaying various portions of the second shared workspace 520. For example, the computing devices 104a-d may display various facts about the countries corresponding to virtual positions associated with the computing devices 104a-d. For example, in response to receiving input from the users for navigating the second shared workspace 520, the computing devices 104a-d can display previously hidden content such, for example, as the national flags of countries corresponding to the virtual positions of the computing devices 104a-d. As shown in FIG. 5, computing devices 104a-d can select certain flags, and the flag selections 530 are presented to the interactive display device 102.

In some aspects, the collaborative system can require the users to simultaneously select an answer to a query provided by the interactive display device 102. Thus, the threshold activity that the shared workspace application 202 can monitor is the combined entry of a specific selection (e.g., the correct answer from multiple possible options) from the computing devices 104a-d within a certain amount of time. Requiring users to simultaneously make a selection can increase the interactivity and collaborative aspects of using the interactive collaboration system in a collaborative setting.

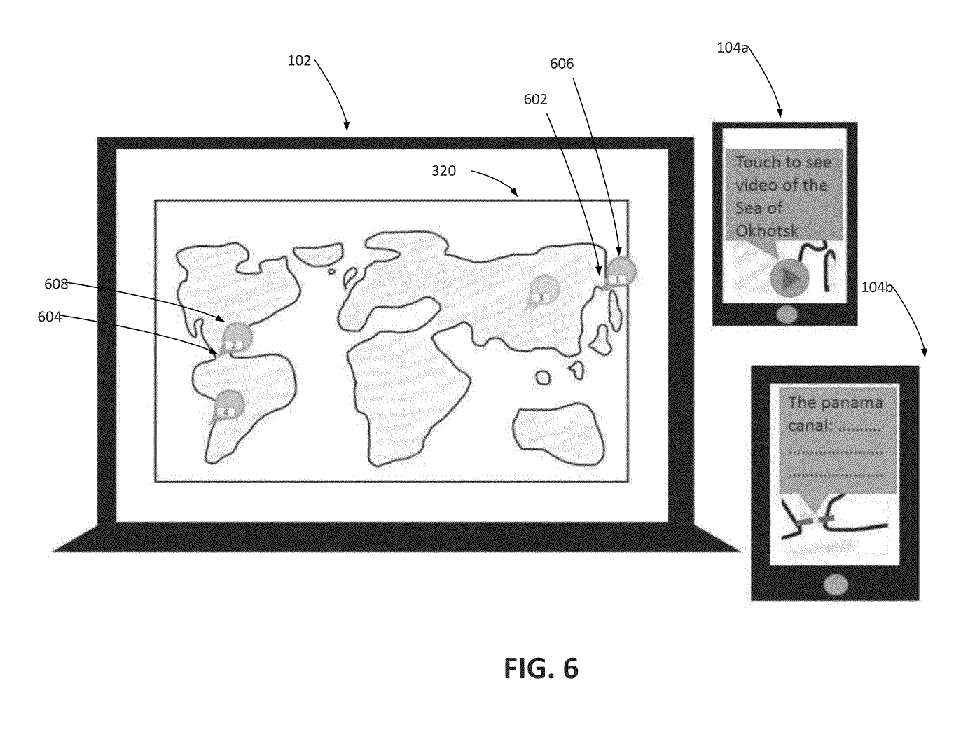

In other aspects, the shared workspace 320 can include linked content that is embedded at specific virtual positions in the shared workspace 320. For example, FIG. 6 depicts a shared workspace 320 that includes linked content embedded at certain locations 602, 604. The linked content can be hidden in the shared workspace 320 such that the linked content is not displayed on the interactive display device 102. The shared workspace application 202 can embed hidden linked content in the shared workspace 320 by storing information indicating the locations and descriptions of linked content in a memory device without depicting the linked content on the interactive display device 102 (e.g., by making such content transparent on the interactive display device 102).

Linked content embedded at different locations in the shared workspace 320 can include audio, video, images, descriptive text, or any other material that can provide more detail when viewed on a computing device. If a portion of the shared workspace 320 that is displayed on a computing device is moved, the associated virtual position within the shared workspace 320 is updated as described above. If the associated virtual position is moved to within a threshold of the hidden embedded content, the computing device displays the linked content. In some aspects, if the associated virtual position is moved to within a threshold of the hidden embedded content, the linked content can be displayed on the interactive display device 102.

FIG. 6 shows computing devices 104a, 104b associated with respective virtual positions 606, 608 in the shared workspace 320. The computing device 104a can receive input selecting a different portion of the shared workspace 320 corresponding to the location 602 having embedded linked content. The computing device 104a can respond to receiving the input by displaying the linked content. In this example, the linked content shown on computing device 104a includes an educational video of the Sea of Okhotsk. A user of the computing device 104b has moved the portion of the shared workspace 320 shown on his or her display to the location 604 of additional embedded linked content. In this example, the linked content can include narrative information on The Panama Canal, displayed on computing device 104b.

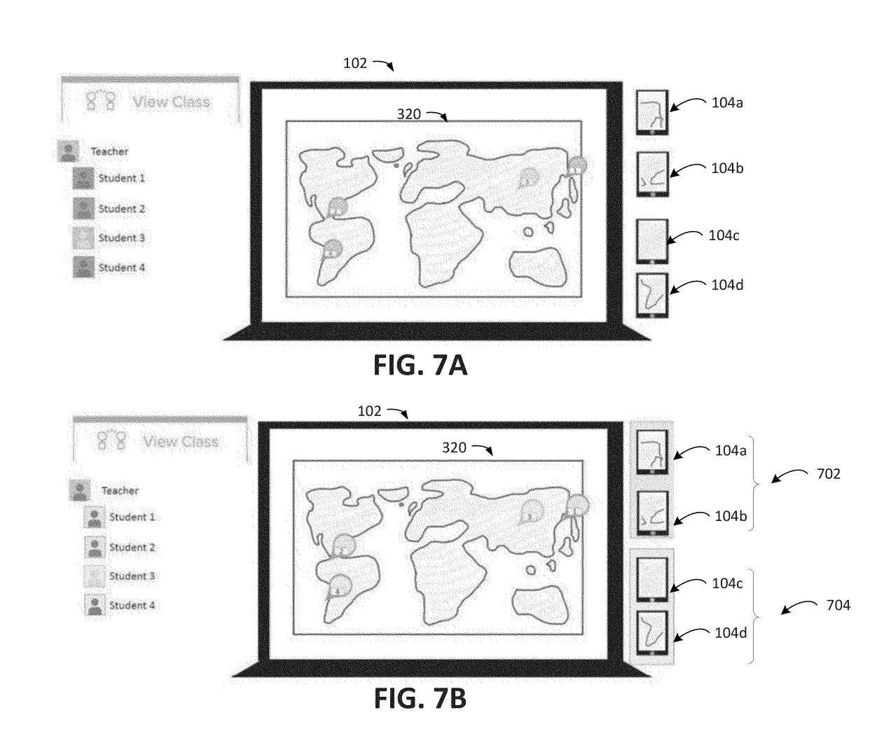

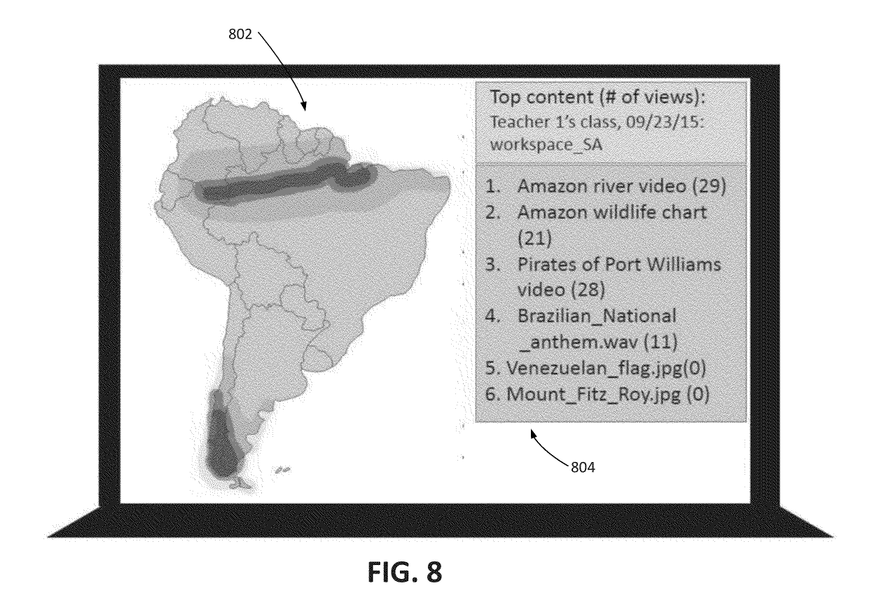

FIGS. 7A, 7B and 8 show examples of how the features described above can be used to facilitate collaboration. For example, the features described above and depicted in FIGS. 7A, 7B and 8 can allow a teacher in an educational setting a flexible approach to providing lecture materials or presenting information to students in an interactive collaborative environment.

In one aspect, different computing devices 104a-d can be grouped into various subsets to perform different tasks. The interactive display device 102 can display the various subsets and distinguish the subsets by color. For example, FIG. 7A shows an interactive display device 102 as shown in a classroom with computing devices 104a-d. The interactive display device 102 can display the virtual positions associated with each of the computing devices 104a-d and update the virtual positions as the displayed portions of the shared workspace 320 on the computing devices 104a-d are moved to different locations.

As shown in FIG. 7B, computing devices 104a-d can be grouped into subsets. FIG. 7B shows computing devices 104a, 104b placed in a subset 702 and computing devices 104c, 104d placed in a subset 704. Different content can be created on the shared workspace 320, each content accessible by a different subset 702, 704. For example, inputs can be provided to the shared workspace application 202 executing on the interactive display device 102 in order to create restricted content. Additional inputs to the shared workspace application 202 can specify which subsets can access such restricted content. Alternatively, inputs to the shared workspace application 202 can specify that a certain number of members of a particular subset can access given restricted content at a time.

For example, FIG. 7B depicts a shared workspace 320 that displays a geographic map of planet Earth. The shared workspace application 202 can be used to create restricted content within the boundaries of the coordinates that mark North and South America and additional restricted content in the boundaries of the coordinates that define Asia. The shared workspace application 202 can further be configured such that one member of subset 702 and one member of subset 704 can access the same restricted content simultaneously. As shown in FIG. 7B, one member of subset 702 and one member of subset 704 can explore the coordinates of the region that mark the Americas, and the second member of subset 702 and the second member of subset 704 can explore the coordinates of the map that define Asia. This allows the users of computing devices 104a-d work together or separately for performing educational projects. Accordingly, aspects and features described can be used to have subsets of the computing devices 104a-d engaged in different activities.

In a further aspect, as users navigate and explore the shared workspace 320 via the computing devices, the shared workspace application 202 can track the associated virtual positions and the actions performed by the computing devices over a period of time. The shared workspace application 202 can configure the interactive display device 102 to display the history of the virtual positions as the users explored the shared workspace 320 through a graphical diagram (e.g., a heat-map) overlaid on a graphical interface of the shared workspace 320 and displayed on the interactive display device 102.

FIG. 8 depicts, for example, a shared workspace 802 that has an overlay of a graphical diagram indicating the historical tracking of virtual positions associated with computing devices. The graphical diagram of coordinates can include darker shaded regions for the coordinates where a greater concentration of users explored the shared workspace 320 via their computing devices. For example, the shared workspace 802 in FIG. 8 includes a map of South America. Users can interact with the shared workspace 802 by manipulating the graphical interfaces of computing devices 104a-d and thereby explore the content in the shared workspace 802 (e.g., explore the virtual map of South America). The computing devices 104a-d can respond to inputs for accessing specific portions of the shared workspace 802 by transmitting or otherwise providing data to the interactive display device 102 for updating the virtual positions associated with the respective computing devices 104a-d. A suitable processing device can execute the shared workspace application 202 to track the virtual position of each of the computing devices 104a-d in response to receiving the data for updating the virtual positions. For example, the shared workspace application 202 can track the coordinate sets and the specific zoom levels for the respective computing devices 104a-d. The historical tracking of the virtual positions and actions performed by each of the computing devices 104a-d can be stored in a memory device that is included in or communicatively coupled to the interactive display device 102. The shared workspace application 202 can execute a process to generate a graphical diagram of the historical tracking information. For example, darker shaded areas of the overlaid graphical diagram can indicate the portions of South America having the greatest number of views.

In additional or alternative aspects, the shared workspace application 202 can configure the interactive display device 102 to display the tracked list of actions performed by each of the computing devices 104a-d. For example, as the users navigate and explore the shared workspace 802 of South America, each user can reveal hidden content from the shared workspace 802 on their respective computing device 104a-d. An example of embedded linked content is a video providing information on the Amazon River. The shared workspace application 202 can execute a process to generate a listing 804 of the actions performed by the computing devices 104a-d. The listing 804 can be ranked based on the number of the computing devices 104a-d that performed each action (i.e., accessed such content).

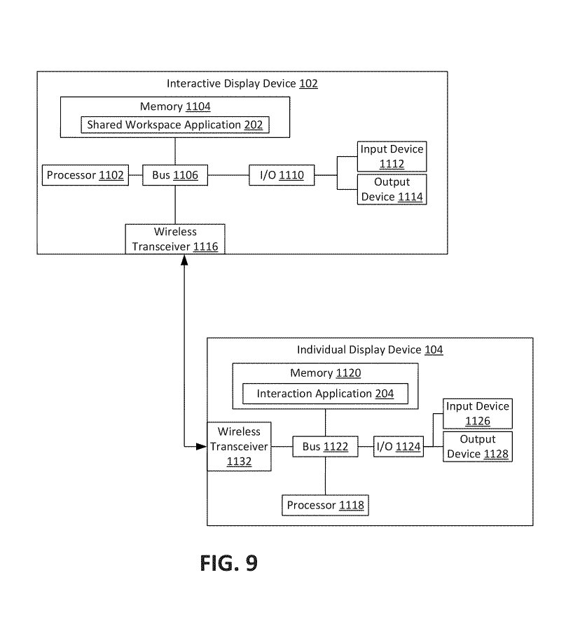

Any suitable system implementation can be used for the devices and methods described above with respect to FIGS. 1-8. For example, FIG. 9 is a block diagram depicting examples of an interactive display device 102 and a computing device 104.

The interactive display device 102 and the computing device 104 can respectively include processors 1102, 1118 that are communicatively coupled to respective memory devices 1104, 1120. The processors 1102, 1118 can execute computer-executable program code and/or access information stored in the memory devices 1104, 1120. The processor 1102 can execute a shared workspace application 202 and/or other computer-executable program code stored in the memory device 1104. The processor 1118 can execute an interaction application 204 and/or other computer-executable program code stored in the memory device 1120. When executed by the processors 1102, 1118 the program code stored in the memory devices 1104, 1120 can cause the processor to perform the operations described herein. Each of the processors 1102, 1118 may include a microprocessor, an application-specific integrated circuit (“ASIC”), a state machine, or other processing device. Each of the processors 1102, 1118 can include any of a number of processing devices, including one.

Each of the memory devices 1104, 1120 can include any suitable computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read program code. The program code may include processor-specific instructions generated by a compiler and/or an interpreter from code written in any suitable computer-programming language, including, for example, C, C++, C#, Visual Basic, Java, Python, Perl, JavaScript, and ActionScript.

The interactive display device 102 and the computing device 104 can also respectively include buses 1106, 1122. Each of the buses 1106, 1122 can communicatively couple one or more components of a respective one of the interactive display device 102 and the computing device 104.

The interactive display device 102 and the computing device 104 can also respectively include a number of external or internal devices. For example, the interactive display device 102 and the computing device 104 can include input/output (“I/O”) interfaces 1110, 1124. Each of the I/O interfaces 1110, 1124 can communicate input events and output events among components of the interactive display device 102 and the computing device 104, respectively. For example, the interactive display device 102 can include one or more input devices 1112 and one or more output devices 1114 and the computing device 104 can include one or more input devices 1126 and one or more output devices 1128. The one or more input devices 1112, 1126 and one or more output devices 1114, 1128 can be communicatively coupled to the I/O interfaces 1110, 1124, respectively. The communicative coupling can be implemented via any suitable manner (e.g., a connection via a printed circuit board, connection via a cable, communication via wireless transmissions, etc.). Non-limiting examples of input devices 1112, 1126 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1114, 1128 include an LCD screen, an external monitor, a speaker, or any other device that can be used to display or otherwise present outputs generated by a computing device.

For illustrative purposes, FIG. 9 depicts input devices 1112, 1126 and output devices 1114, 1128 as included in the interactive display device 102 and the computing device 104. However, any suitable implementation of an interactive display device 102 and/or a computing device 104 with respect to the input devices 1112, 1126 and output devices 1114, 1128 can be used. For example, a device such as a touch screen can be separate from and communicatively coupled to a computing device. A touch screen can function as both an input device and an output device.

The interactive display device 102 can also include one or more wireless transceivers 1116 and the computing device 104 can include one or more wireless transceivers 1132. The wireless transceivers 1116, 1132 can include any device or group of devices suitable for establishing a wireless data connection. Non-limiting examples of the wireless transceivers 1116, 1132 include one or more of an Ethernet network adapter, an RF transceiver, a modem, an optical emitter, an optical transceiver, etc.

Although, for illustrative purposes, FIG. 9 depicts the processor 1102, the memory device 1104, the bus 1106, the I/O interface 1110, the input device 1112, the output device 1114, and the wireless transceiver 1116 as being included within the interactive display device 102, other implementations are possible. For example, in some aspects, one or more of the processor 1102, the memory device 1104, the bus 1106, the I/O interface 1110, the input device 1112, the output device 1114, and the wireless transceiver 1116 can be separate devices that are communicatively coupled with one or more other components of the interactive display device 102. In additional or alternative aspects, one or more of the processor 1102, the memory device 1104, the bus 1106, the I/O interface 1110, the input device 1112, the output device 1114, and the wireless transceiver 1116 can be included in a separate computing device (e.g., a server) that is communicatively coupled with one or more other components of the interactive display device 102.

In some aspects, a computing system or environment can include at least one interactive display device 102. In additional or alternative aspects, a system can be formed by establishing communication between at least one interactive display device 102 and multiple computing devices 104.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method, comprising:
displaying a graphical interface corresponding to a shared workspace on an interactive display device;
updating the graphical interface to depict respective virtual positions associated with each of a plurality of computing devices, wherein, for each of the plurality of computing devices, the interactive display device provides access to a respective portion of the shared workspace indicated by the respective virtual position associated with the computing device; and
triggering an action on the interactive display device based on determining that a subset of computing devices from the plurality of computing devices have performed a threshold activity.

2. The method of claim 1, wherein triggering the action on the interactive display device includes updating the graphical interface to depict an additional shared workspace, the additional shared workspace comprising a subset of the shared workspace.

3. The method of claim 2, wherein the threshold activity includes moving the virtual positions respectively associated the subset of computing devices within a threshold distance of a location or set of locations in the shared workspace.

4. The method of claim 1, wherein determining that the subset of computing devices have performed a threshold activity comprises determining whether the each of the subset of computing devices has selected a correct answer from a group of possible answers presented on the graphical interface.

5. The method of claim 1, wherein the interactive display device further provides access to hidden content in the shared workspace, wherein the hidden content is not displayed by the interactive display device.

6. The method of claim 1, further comprising:
selecting an additional subset of computing devices from the plurality of computing devices; and
creating a restricted portion of the shared workspace, wherein the restricted portion of the shared workspace allows access to the additional subset of computing devices and prevents access by at least some of the plurality of computing devices.

7. The method of claim 1, further comprising:
monitoring the virtual positions associated with the plurality of computing devices and actions performed by the plurality of computing devices over a period of time; and
indicating, on the shared workspace, a graphical representation of the virtual positions associated with the plurality of computing devices over the period of time.

8. The method of claim 7, further comprising presenting a list of the actions performed by the plurality of computing devices, wherein the list of the actions is ranked by a number of the computing devices that performed each action.

9. The method of claim 1, further comprising embedding linked content at a location in the shared workspace, wherein the linked content is not displayed on the shared workspace, wherein triggering the action comprises providing a display of the linked content to at least one computing device of the subset of computing devices, wherein the threshold activity comprises the respective virtual position of the at least one computing device being moved within a threshold distance of the location.

10. The method of claim 1, further comprising identifying hidden portions of the shared workspace, wherein the hidden portions of the shared workspace are not initially displayed on the interactive display device;
wherein the threshold activity includes moving the respective virtual positions associated with a subset of the plurality of computing devices to the hidden portions of the shared workspace;
wherein triggering the action on the interactive display device includes displaying the hidden portions of the shared workspace.

11. A system comprising:
a processing device;
a non-transitory computer-readable medium communicatively coupled to the processing device, wherein the processing device is configured for executing program code stored in the non-transitory computer-readable medium to perform operations comprising:
displaying a graphical interface corresponding to a shared workspace on an interactive display device;
updating the graphical interface to depict respective virtual positions associated with each of a plurality of computing devices, wherein, for each of the plurality of computing devices, the interactive display device provides access to a respective portion of the shared workspace indicated by the respective virtual position associated with the computing device; and
triggering an action on the interactive display device based on determining that a subset of computing devices from the plurality of computing devices have performed a threshold activity.

12. The system of claim 11, wherein triggering the action on the interactive display device includes updating the graphical interface to depict an additional shared workspace, the additional shared workspace comprising a subset of the shared workspace.

13. The system of claim 12, wherein the threshold activity includes moving the virtual positions respectively associated with the subset of computing devices within a threshold distance of a location or set of locations in the shared workspace.

14. The system of claim 11, wherein determining that the subset of computing devices have performed a threshold activity comprises determining whether the each of the subset of computing devices has selected a correct answer from a group of possible answers presented on the graphical interface.

15. The system of claim 11, wherein the interactive display device further provides access to hidden content in the shared workspace, wherein the hidden content is not displayed by the interactive display device.

16. The system of claim 11, wherein the non-transitory computer-readable medium further includes program code to perform operations comprising:
selecting an additional subset of computing devices from the plurality of computing devices; and
creating a restricted portion of the shared workspace, wherein the restricted portion of the shared workspace allows access to the additional subset of computing devices and prevents access by at least some of the plurality of computing devices.

17. The system of claim 11, wherein the non-transitory computer-readable medium further includes program code to perform operations comprising:
monitoring the virtual positions associated with the plurality of computing devices and actions performed by the plurality of computing devices over a period of time; and
indicating, on the shared workspace, a graphical representation of the virtual positions associated with the plurality of computing devices over the period of time.

18. The system of claim 17, wherein the non-transitory computer-readable medium further includes program code to perform operations comprising:
presenting a list of the actions performed by the plurality of computing devices, wherein the list of the actions is ranked by a number of the computing devices that performed each action.

19. The system of claim 11, wherein the non-transitory computer-readable medium further includes program code to perform operations comprising:
embedding linked content at a location in the shared workspace, wherein the linked content is not displayed on the shared workspace, wherein triggering the action comprises providing a display of the linked content to at least one computing device of the subset of computing devices, wherein the threshold activity comprises the respective virtual position of the at least one computing device being moved within a threshold distance of the location.

20. The system of claim 11, wherein the non-transitory computer-readable medium further includes program code to perform operations comprising:
identifying hidden portions of the shared workspace, wherein the hidden portions of the shared workspace are not initially displayed on the interactive display device;
wherein the threshold activity includes moving the respective virtual positions associated with a subset of the plurality of computing devices to the hidden portions of the shared workspace;
wherein triggering the action on the interactive display device includes displaying the hidden portions of the shared workspace.
